(19) United States
(12) Patent Application Publication
(10) Pub. No.: US 2011/0117975 A1
(43) Pub. Date: May 19, 2011

(54) Two-Way Communication Device

(75) Inventors: William Frank Dunn, Austin, TX (US); Stephen Berger, Georgetown, TX (US); Timothy Milam, Round Rock, TX (US)

(73) Assignee: Etymotic Research, Inc., Elk Grove Village, IL (US)

(21) Appl. No.: 12/619,800

(22) Filed: Nov. 17, 2009

(51) Int. Cl. H04M 1/02

(52) U.S. Cl. 455/575.1; 381/355

(57) ABSTRACT

Certain embodiments provide improved two-way communication devices, such as wireless headsets, including a port configured to deliver sound, a circuit board operatively connected to the port, an antenna configured to receive wireless transmissions, the antenna operatively connected to the circuit board and positioned at a first end of the circuit board and a boom including a microphone configured to receive sound, the boom operatively connected to the circuit board via a wire configured to run across a ground plane of the antenna. Certain embodiments provide fixed booms, other embodiments provide removable booms.

### CROSS-REFERENCE TO RELATED APPLICATIONS/INCORPORATION BY REFERENCE

U.S. patent application Ser. No. 12/348,954, by Dunn et al., published on Jul. 9, 2009 as U.S. Publication No. 2009/0176538, is incorporated by reference herein in its entirety.

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

Wireless headsets for use with telephones (or other devices, such as a computer, for example) are useful in many instances, such as when hands-free use of the telephone is desired, for example. Current wireless headsets can provide many benefits to users. However, for some users, there is excessive “pop” and “click” noise when a telephone (or other device) being used in connection with a wireless headset is positioned away from the headset, such as when a telephone is placed in a pants pocket, for example.

There is therefore a need for an improved wireless headset that provides for reduced “pop” and “click” noise when a telephone (or other device) being used in connection with the headset is positioned away from the headset.

### SUMMARY OF THE INVENTION

Embodiments of the present technology provide improved two-way communication devices and methods of providing wireless two-way communication using such devices.

In certain embodiments, a two-way communication device includes: a port configured to deliver sound; a circuit board operatively connected to the port; an antenna configured to receive wireless transmissions, the antenna operatively connected to the circuit board and positioned at a first end of the circuit board; and a fixed boom including a microphone configured to receive sound, the boom terminating a distance from the antenna such that the boom does not run across the antenna, the boom electrically connected to the circuit board at the first end via a wire configured to run across the antenna. In certain embodiments, the boom terminates at least about 3 millimeters from the antenna. In certain embodiments, the wire comprises a plurality of individually insulated strands. In certain embodiments, the device further includes a connector configured to receive a charging jack, the connector operatively connected to the circuit board and positioned at a second end of the circuit board, the second end being opposite the first end. In certain embodiments, the device further includes a battery positioned between the connector and the antenna. In certain embodiments, the device is a wireless headset. In certain embodiments, the device is used in wireless communication range with a second two-way communication device, and wherein the device does not experience signal interruptions based on the location of the device relative to the second two-way communication device.

In certain embodiments, a two-way communication device includes: a port configured to deliver sound; a circuit board operatively connected to the port, the circuit board comprising board contacts configured to provide electrical communication with boom contacts when a removable boom is attached; an antenna configured to receive wireless transmissions, the antenna operatively connected to the circuit board and positioned at a first end of the circuit board; and a removable boom including a microphone configured to receive sound, the boom further including a plug including boom contacts, the microphone in electrical communication with the boom contacts via a wire, the boom configured to be electrically connected with the circuit board at the first end using the boom contacts and the board contacts when the boom is attached, the boom configured such that only the plug runs across the antenna when the boom is attached, the boom configured such that the wire runs across the antenna when the boom is attached. In certain embodiments, the circuit board further comprises a retention device configured to receive the plug. In certain embodiments, the board contacts comprise a positive spring contact and a negative spring contact, the board contacts configured to matingly engage the boom contacts when the removable boom is attached. In certain embodiments, the board contacts and the boom contacts are positioned near an edge of a ground plane of the antenna when the boom is attached. In certain embodiments, the antenna resonates at a frequency and the board contacts and boom contacts do not resonate at the frequency. In certain embodiments, the board contacts comprise nickel plated spring steel with a thickness of 0.16 millimeters. In certain embodiments, the boom contacts comprise nickel plated spring steel with a thickness of 0.32 millimeters. In certain embodiments, the wire comprises a plurality of individually insulated strands. In certain embodiments, the device further includes a connector configured to receive a charging jack, the connector operatively connected to the circuit board and positioned at a second end of the circuit board, the second end being opposite the first end. In certain embodiments, the device further includes a battery positioned between the connector and the antenna. In certain embodiments, the device is a wireless headset. In certain embodiments, the device is used in wireless communication range with a second two-way communication device, wherein the device does not experience signal interruptions based on the location of the device relative to the second two-way communication device.

In certain embodiments, a two-way communication device includes: a circuit board; an antenna configured to receive wireless transmissions, the antenna operatively connected to the circuit board; and a boom including a microphone configured to receive sound, the boom terminating a distance from the antenna, the boom electrically connected to the circuit board via a wire configured to run across the antenna.

### BRIEF DESCRIPTION OF THE DRAWING(S)

FIG. 1 is a diagram depicting a configuration of a prior art wireless headset.

FIG. 2 is a diagram depicting a configuration of a wireless headset used in accordance with an embodiment of the present technology.

FIG. 2A is a diagram depicting a configuration of a wireless headset used in accordance with an embodiment of the present technology.

FIG. 3 is a side view of a wireless headset with detachable boom used in accordance with an embodiment of the present technology.

FIG. 4 is a perspective view of the wireless headset with detachable boom depicted in FIG. 3.

FIG. 5 is a top-perspective view of the portion indicated by A of the wireless headset with detachable boom depicted in FIG. 3.

FIG. 6 is a side-perspective view of the portion indicated by A of the wireless headset with detachable boom depicted in FIG. 3.

FIG. 7 is a perspective view of a boom contact used in accordance with an embodiment of the present technology.

FIG. 8 is a perspective view of a positive board contact used in accordance with an embodiment of the present technology.

FIG. 9 is a perspective view of a negative board contact used in accordance with an embodiment of the present technology.

The foregoing summary, as well as the following detailed description of embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF PREFERRED EMBODIMENT(S)

FIG. 1 is a diagram depicting a configuration of a prior art wireless headset 100. In this configuration, an antenna 102 that receives wireless transmissions is positioned at a first end of a circuit board 110. At the other end of the circuit board 110 is a connector 108 configured to receive a charging jack and/or a plug 106 of a detachable boom 104. Between the connector 108 and the antenna 102 is a battery 112.

The headset would also include a housing, a sound port configured to deliver sound to an ear canal, microphones to receive sound, for example, positioned at the end of the detachable boom 104 and at the end of the housing that is configured to receive the detachable boom. Wireless headsets with configurations similar to those depicted in FIG. 1 are described, for example, in U.S. patent application Ser. No. 12/348,954, by Dunn et al., published on Jul. 9, 2009 as U.S. Publication No. 2009/0176538, which application is incorporated by reference herein in its entirety.

Wireless headsets with configurations similar to those depicted in FIG. 1 can result in what a user may consider to be excessive “pop” and “click” noise when a telephone being used in connection with the headset is positioned away from the headset, such as when the telephone is placed in a pants pocket, for example.

It has been discovered that such noise is the result of lost audio signals when data packets are not received by the wireless headset. Notably, wireless transmissions, such as those used to communicate data packets between a telephone and a wireless headset using Bluetooth technology, are frequency hopping and use all channels (79 channels for Bluetooth transmissions) with a single packet being transmitted in each channel.

Testing was conducted in order to determine the transmit/receive field from a wireless headset. Because transmit and receive antenna patterns are symmetrical, only the transmit function was tested. A simulated wireless headset user comprising a fiberglass torso (with head) was filled with water and positioned on a turn table. The transmit field from the wireless headset was then tested over all channels using a probe (representing a virtual telephone location) to detect transmissions. It was discovered that, with the probe (virtual telephone) at waist level, at least 2 or 3 channels (of the 79 channels) exhibited a deep fade. In other words, a packet would always be lost on those channels.

Antenna redesign was attempted, but the deep fades at various channels remained. Continued testing and redesigning resulted in discovery of the improved wireless headset configurations described herein.

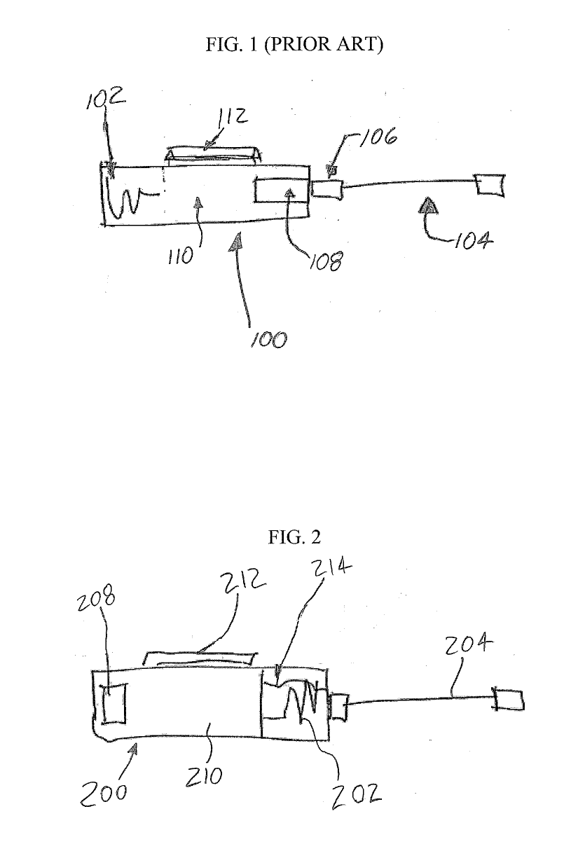

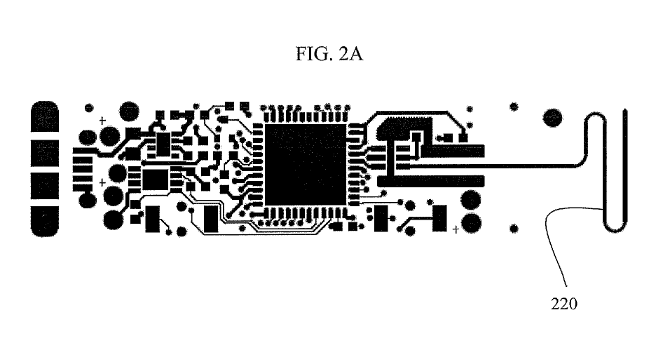

FIG. 2 is a diagram depicting a configuration of a wireless headset used in accordance with an embodiment of the present technology. In this configuration, an antenna 202 that receives wireless transmissions is positioned at a first end of a circuit board 210. At the other end of the circuit board 210 is a connector 208 configured to receive a charging jack. Between the connector 208 and the antenna 202 is a battery 212. A boom 204 is fixedly attached at the same end of the circuit board 210 as the antenna 202, at least about 3-4 millimeters from the end of the antenna, thereby reducing interference from the boom on antenna performance. Wire 214 is used to connect the microphone of boom 204 to the circuit board 210. Wire 214 is configured to run across the ground plane of the antenna 202, thereby reducing the presence of potentially interfering material, such as metal, for example, over the ground plane. Wire 214 can comprise Litz wire, which includes a plurality of individually insulated strands. Acceptable litz wire sizes can include at least about 7 strands of 28-40 American Wire Gauge (AWG), including 32 AWG or 34 AWG, for example. It has been found that the individual insulation of strands can also reduce impact of the wire on antenna performance.

This configuration was found to correct the deep fade issue that was experienced in connection with the configuration depicted in FIG. 1. Various antenna configurations were found to be acceptable, including the configuration of antenna 220 shown in FIG. 2A. It was also found that an increased link budget of at least about 6 dB between the wireless headset and the probe (virtual telephone) was acceptable to compensate for the occurrence of audio noise from radiofrequency fades across all channels.

The embodiment described in connection with FIG. 2 refers to a fixed boom embodiment. It has been found that a similar approach can also be applied to detachable boom configurations, however, detachable boom configurations provide unique challenges. For example, detachable booms used in connection with wireless headsets often have relatively large amounts of metal at a plug portion that interfaces with the headset body, and provides connection to the circuit board. It has been found that using such plugs in the configuration described in connection with FIG. 2 would result in unacceptable interference with the antenna, as much of the metal would be positioned over the ground plane of the antenna.

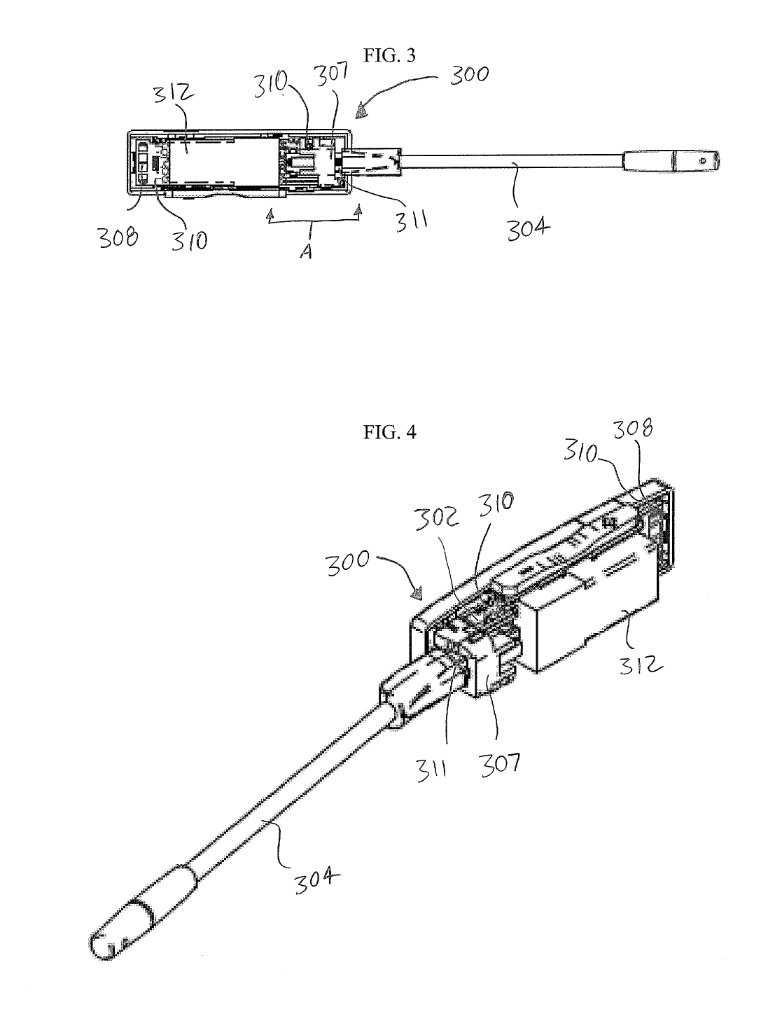

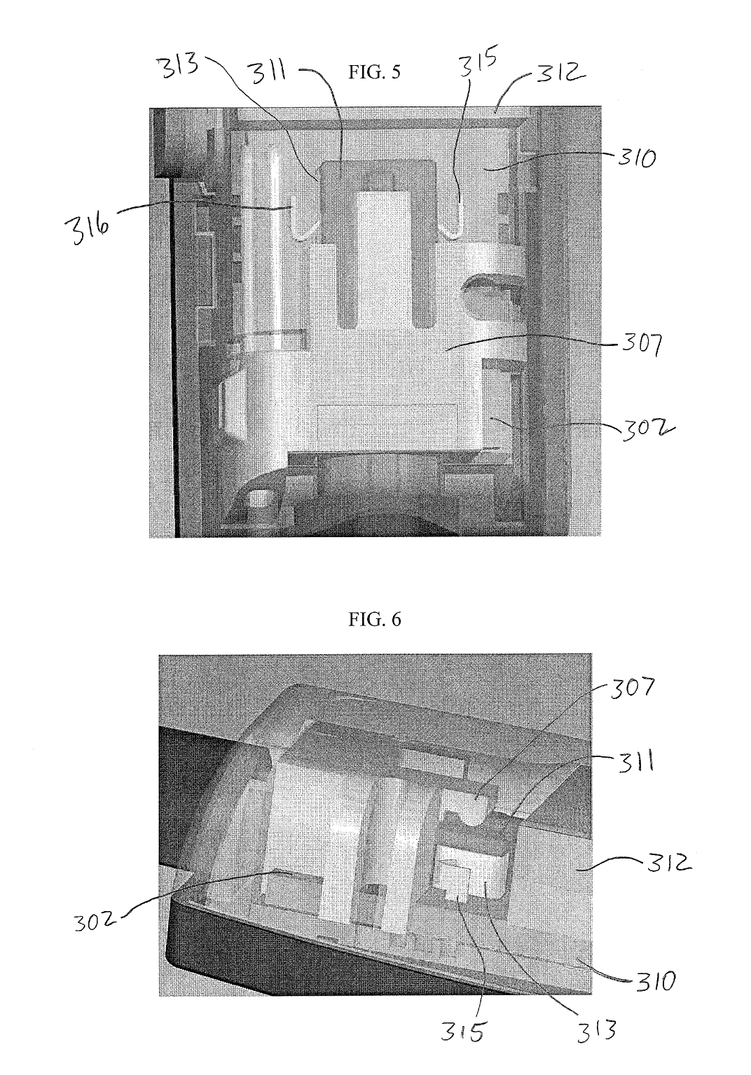

FIG. 3 and FIG. 4 depict a wireless headset 300 with detachable boom 304 used in accordance with an embodiment of the present technology. FIG. 5 and FIG. 6 depict the portion indicated by A of the wireless headset 300 with detachable boom 304 depicted in FIG. 3. In this configuration, an antenna 302 that receives wireless transmissions is positioned at a first end of a circuit board 310 (printed on the circuit board 310). At the other end of the circuit board 310 is a connector 308 configured to receive a charging jack. Between the connector 308 and the antenna 302 is a battery 312. A detachable boom 304 is configured to be removably attached at the same end of the circuit board 310 as the antenna 302. The detachable boom 304 includes a plug 311 comprising plastic and two boom contacts 313 (see FIG. 5 and FIG. 6). A wire connects the boom contacts 313 to the boom microphone. The circuit board 310 includes a retention device 307 configured to receive the plug 311. Attached to the circuit board 310 are two board contacts, one positive board contact 315, and one negative board contact 316, that are configured as springs that matingly engage the boom contacts 313 (see FIG. 5 and FIG. 6) when the boom 304 is attached to the headset. The contacts 313, 315, 316 are near the edge of the ground plane of the antenna 302. Also, similar to wire 214 described in connection with FIG. 2, the wire that connects the boom contacts 313 to the boom microphone is configured to run across the ground plane of the antenna 302, thereby reducing the presence of potentially interfering material, such as metal, for example, over the ground plane. As described in connection with FIG. 2, the wire can comprise Litz wire. Also, the wire and contacts 313, 315, 316, which include a relatively small amount of metal, should not resonate at the frequency of the antenna, which is 2.4 Ghz in certain embodiments.

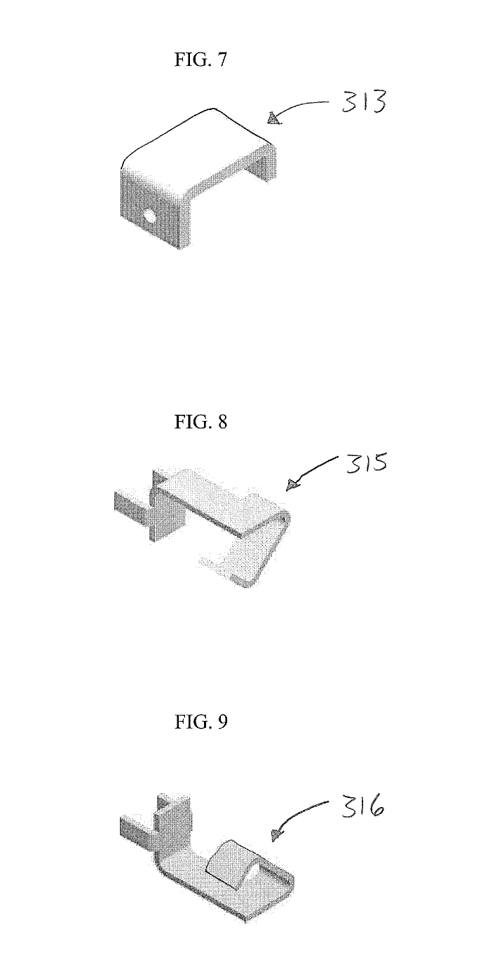

FIG. 7 depicts boom contact 313. In certain embodiments, the boom contacts 313 can comprise nickel plated spring steel that is 0.32 mm thick. As discussed above, the boom contacts 313 can be configured to be attachable to an end of the boom plug 311.

FIG. 8 depicts positive board contact 315 and FIG. 9 depicts negative board contact 316. In certain embodiments, board contacts 315, 316 can comprise nickel plated spring steel that is 0.16 mm thick. As discussed above, the board contacts can be configured to be attachable the circuit board 310.

The configuration described in connection with FIGS. 3-9 was found to correct the deep fade issue that was experienced in connection with the configuration depicted in FIG. 1.

Methods of providing wireless two-way communication using devices as described herein will be evident to those skilled in the art based on the present disclosure.

While particular elements, embodiments and applications of the present invention have been shown and described, it will be understood, that the invention is not limited thereto since modifications can be made by those skilled in the art without departing from the scope of the present disclosure, particularly in light of the foregoing teachings.

What is claimed is:

1. A two-way communication device comprising:
a port configured to deliver sound;
a circuit board operatively connected to the port;
an antenna configured to receive wireless transmissions, the antenna operatively connected to the circuit board and positioned at a first end of the circuit board; and
a fixed boom including a microphone configured to receive sound, the boom terminating a distance from the antenna such that the boom does not run across the antenna, the boom electrically connected to the circuit board at the first end via a wire configured to run across the antenna.

2. The device of claim 1, wherein the boom terminates at least about 3 millimeters from the antenna.

3. The device of claim 1, wherein the wire comprises a plurality of individually insulated strands.

4. The device of claim 1, further comprising a connector configured to receive a charging jack, the connector operatively connected to the circuit board and positioned at a second end of the circuit board, the second end being opposite the first end.

6. The device of claim 5, further comprising a battery positioned between the connector and the antenna.

7. The device of claim 1, wherein the device is a wireless headset.

8. The device of claim 1, wherein the device is used in wireless communication range with a second two-way communication device, and wherein the device does not experience signal interruptions based on the location of the device relative to the second two-way communication device.

9. A two-way communication device comprising:
a port configured to deliver sound;
a circuit board operatively connected to the port, the circuit board comprising board contacts configured to provide electrical communication with boom contacts when a removable boom is attached;
an antenna configured to receive wireless transmissions, the antenna operatively connected to the circuit board and positioned at a first end of the circuit board; and
a removable boom including a microphone configured to receive sound, the boom further including a plug including boom contacts, the microphone in electrical communication with the boom contacts via a wire, the boom configured to be electrically connected with the circuit board at the first end using the boom contacts and the board contacts when the boom is attached, the boom configured such that only the plug runs across the antenna when the boom is attached, the boom configured such that the wire runs across the antenna when the boom is attached.

10. The device of claim 9, wherein the circuit board further comprises a retention device configured to receive the plug.

11. The device of claim 9, wherein the board contacts comprise a positive spring contact and a negative spring contact, the board contacts configured to matingly engage the boom contacts when the removable boom is attached.

12. The device of claim 9, wherein the board contacts and the boom contacts are positioned near an edge of a ground plane of the antenna when the boom is attached.

13. The device of claim 9, wherein the antenna resonates at a frequency and the board contacts and boom contacts do not resonate at the frequency.

14. The device of claim 9, wherein the board contacts comprise nickel plated spring steel with a thickness of 0.16 millimeters.

15. The device of claim 9, wherein the boom contacts comprise nickel plated spring steel with a thickness of 0.32 millimeters.

16. The device of claim 9, wherein the wire comprises a plurality of individually insulated strands.

17. The device of claim 9, further comprising a connector configured to receive a charging jack, the connector operatively connected to the circuit board and positioned at a second end of the circuit board, the second end being opposite the first end.

18. The device of claim 17, further comprising a battery positioned between the connector and the antenna.

19. The device of claim 9, wherein the device is a wireless headset.

20. The device of claim 9, wherein the device is used in wireless communication range with a second two-way communication device, and wherein the device does not experience signal interruptions based on the location of the device relative to the second two-way communication device.

21. A communication device comprising:
a circuit board;
an antenna configured to receive wireless transmissions, the antenna operatively connected to the circuit board; and
a boom including a microphone configured to receive sound, the boom terminating a distance from the antenna, the boom electrically connected to the circuit board via a wire configured to run across the antenna.
